(19) United States
(12) Patent Application Publication
(10) Pub. No.: US 2015/0235149 A1
(43) Pub. Date: Aug. 20, 2015

(54) METHODS AND SYSTEMS FOR EVALUATING PERFORMANCE OF PRINT PRODUCTION ENVIRONMENTS

(71) Applicant: Xerox Corporation, Norwalk, CT (US)

(72) Inventors: Sudhendu Rai, Fairport, NY (US); Eric Michael Gross, Rochester, NY (US)

(73) Assignee: Xerox Corporation, Norwalk, CT (US)

(21) Appl. No.: 14/183,752

(22) Filed: Feb. 19, 2014

(51) Int. Cl. G06Q 10/06; G06Q 10/04; G06Q 10/08

(52) U.S. Cl. CPC G06Q 10/067; G06Q 10/087; G06Q 10/04

(57) ABSTRACT

A method of simulating performance of a print production environment may include receiving, by a computing device, print production environment information that comprises one or more of the following: inventory information from a warehouse management system, worker information from a people management system, equipment information from an equipment management system, or job information from a job management system. The method may include receiving, by the computing device, a performance parameter associated with the print production environment, and performing, by the computing device, a simulation of operation of the print production environment using the received print production environment information to determine an impact of the performance parameter on the print production environment's performance.

### BACKGROUND

A manufacturing execution system (MES) typically coordinates people, processes, equipment and materials for a production environment. However, current MESs do not possess the capability to predict future performance of the production environment based on its real-time state.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of simulating performance of a print production environment may include receiving, by a computing device, print production environment information that comprises one or more of the following: inventory information from a warehouse management system, worker information from a people management system, equipment information from an equipment management system, or job information from a job management system. The inventory information may include real-time information pertaining to one or more inventory items in a print production environment, and the worker information may include real-time information pertaining to one or more workers in the print production environment. The equipment information may include real-time information pertaining to one or more production devices in the print production environment, and the job information may include real-time information pertaining to one or more print jobs being processed by the print production environment. The method may include receiving, by the computing device, a performance parameter associated with the print production environment, and performing, by the computing device, a simulation of operation of the print production environment using the received print production environment information to determine an impact of the performance parameter on the print production environment's performance.

In an embodiment, a system of simulating performance of a print production environment may include a computing device and a computer-readable storage medium. The computer-readable storage medium may include one or more programming instructions that, when executed, cause the computing device to receive print production environment information that comprises one or more of the following: inventory information from a warehouse management system, worker information from a people management system, equipment information from an equipment management system, or job information from a job management system. The inventory information may include real-time information pertaining to one or more inventory items in a print production environment, and the worker information may include real-time information pertaining to one or more workers in the print production environment. The equipment information may include real-time information pertaining to one or more production devices in the print production environment, and the job information may include real-time information pertaining to one or more print jobs being processed by the print production environment. The computer-readable storage medium may include one or more programming instructions that, when executed, cause the computing device to receive a performance parameter associated with the print production environment, and perform a simulation of operation of the print production environment using the received print production environment information to determine an impact of the performance parameter on the print production environment's performance.

### BRIEF DESCRIPTION OF THE DRAWINGS

FIG. 1 illustrates an example manufacturing execution system for a production environment according to an embodiment.

FIG. 2 illustrates an example method of simulating performance of a production environment according to an embodiment.

FIG. 3 illustrates a block diagram of example hardware that may be used to contain or implement program instructions according to an embodiment.

### DETAILED DESCRIPTION

The following terms shall have, for purposes of this application, the respective meanings set forth below:

A “computing device” refers to a device that includes a processor and non-transitory, computer-readable memory. The memory may contain programming instructions that, when executed by the processor, cause the computing device to perform one or more operations according to the programming instructions. As used in this description, a “computing device” may be a single device, or any number of devices having one or more processors that communicate with each other and share data and/or instructions. Examples of computing devices include personal computers, servers, mainframes, gaming systems, televisions, and portable electronic devices such as smartphones, personal digital assistants, cameras, tablet computers, laptop computers, media players and the like.

An “inventory item” refers to a material used by a production environment. An inventory item may be a consumable or other replenishable or replaceable materials. For instance, in a print production environment, an inventory item may include, without limitation, toner, paper, pre-printed inserts, envelopes or other media.

A “job” refers to a logical unit of work that is to be completed. For example, in a print production environment, a job may include one or more print jobs from one or more clients.

A “print job” refers to a job processed in a print shop. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “production device” device refers to a device used to process at least a portion of a job. Examples of production devices in a print shop may include, without limitation, printers, inserters, binders, punchers, collators, multi-function devices or other similar equipment and/or the like.

A “production environment” refers to machine and/or human labor used to complete one or more jobs. A production environment may include one or more devices or other equipment that may be used to complete one or more jobs. Example production environments may include, without limitation, a print production environment, a chemical production environment, a vehicle production environment, a computing device manufacturing production environment, and/or other manufacturing production environments.

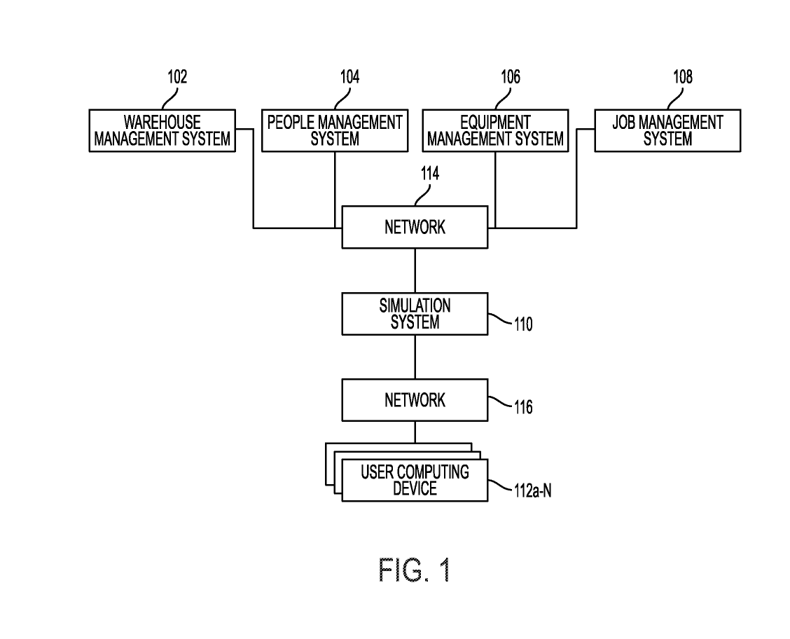

FIG. 1 illustrates an example manufacturing execution system (MES) for a production environment according to an embodiment. As illustrated by FIG. 1, a MES 100 may include a warehouse management system 102, a people management system 104, an equipment management system 106, a job management system 108, a simulation system 110, and one or more user computing devices 112a-N. As illustrated by FIG. 1, a warehouse management system 102, a people management system 104, an equipment management system 106, a job management system 108, and a user computing device 112a-N may each communicate with a simulation system 110 via one or more communication networks 114, 116. In an embodiment, the warehouse management system 102, a people management system 104, an equipment management system 106, a job management system 108, and a user computing device 112a-N may communicate with one another via one or more communication networks. In an embodiment, a communication network 114, 116 may be a local area network (LAN), a wide area network (WAN), a mobile or cellular communication network, an extranet, an intranet, the Internet and/or the like.

A warehouse management system 102 may track or otherwise monitor the movement, storage and/or inventory of one or more inventory items of a production environment. For example, in a print production environment, a warehouse management system 102 may track the movement, storage, supply and/or inventory of print consumables such as, for example, toner, paper and/or other media. In an embodiment, a warehouse management system 102 may manage one or more bill of material (BOM) requirements for a production environment. A warehouse management system 102 may be implemented as software, hardware or a combination of software and hardware using one or more computing devices.

In an embodiment, a people management system 104 may track the abilities and/or availabilities of one or more workers in a production environment. For example, a people management system may include information about workers' skill sets, schedules and/or the like. For instance, in a print production environment, a people tracking system may include information pertaining to which print devices a device operator has experience operating, a schedule of when a device operator works, an indication of which print-related skills an operator has experience and/or the like. A people management system 104 may be implemented as software, hardware or a combination of software and hardware using one or more computing devices.

In an embodiment, an equipment management system 106 may track information pertaining to one or more computing or other devices in a production environment. Such information may include one or more device capabilities or functionalities, specification information or other manufacturing information associated with a device such as, for example, a model indicator, a serial number, and/or the like, and/or information pertaining to a current operational state of a device. An equipment management system 106 may be implemented as software, hardware or a combination of software and hardware using one or more computing devices.

A job management system 108 may track and monitor information pertaining to one or more jobs to be processed by a production environment. Job information may include, without limitation, a job volume, a job composition, a job workflow, one or more tasks that are to be performed on a job, arrival times, completion times, due dates, processing times and/or the like. For example, in the context of a print environment, job information may include a number of print jobs received over a period of time, the number of pages for each received job, the actual and projected processing times for the print jobs and/or the like. Additional and/or alternate job information may be used within the scope of this disclosure. In an embodiment, a job management system 108 may be implemented as software, hardware or a combination of software and hardware using one or more computing devices.

As illustrated by FIG. 1, each of a warehouse management system 102, a people management system 104, an equipment management system 106 and a job management system 108 may communicate with a simulation system 110. A simulation system 110 may simulate operation of a production environment using various parameters to anticipate or estimate the performance of the production environment in certain situations. In an embodiment, a simulation system 110 may use information it receives from the warehouse management system 102, people management system 104, equipment management system 106 and/or job management system 108 to run one or more simulations.

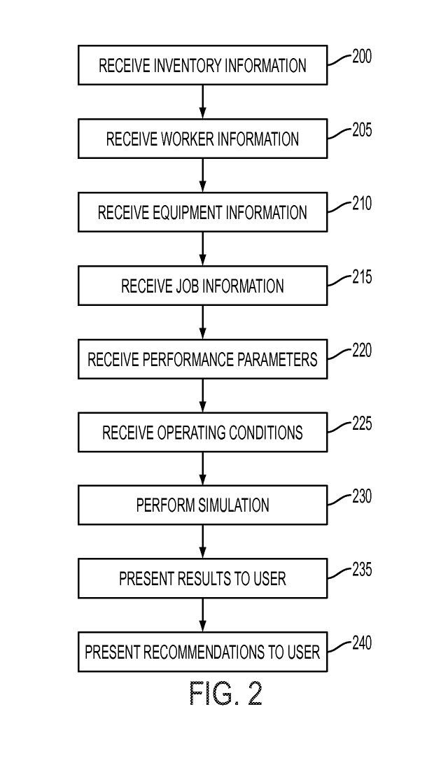

FIG. 2 illustrates an example method of simulating performance of a production environment according to an embodiment. As illustrated by FIG. 2, a simulation system may receive 200 information from a warehouse management system. The received information may include inventory information associated with one or more inventory items of the production environment. Inventory information may include real-time information pertaining to the inventory of one or more inventory items of the production environment. Example inventory information may include, without limitation, an indication of an identity of an inventory item, a currently amount of the inventory item, an indication of the person, device, group and/or the like that uses the inventory item, an indication of the frequency with which the inventory item is used by the production environment, and/or the like. Table 1 illustrates example inventory information according to an embodiment.

TABLE 1

| SKU | Cell | Quantity | Frequency |
|---|---|---|---|
| SKU 9 | Black and white small jobs | 12 | 3 |
| SKU 8 | Black and white small jobs | 84 | 3 |
| SKU 7 | Black and white small jobs | 117 | 6 |
| SKU 6 | Color small jobs | 42 | 6 |
| SKU 5 | Color small jobs | 348 | 6 |
| SKU 4 | Color small jobs | 762 | 6 |
| SKU 3 | Color large jobs | 867 | 6 |
| SKU 2 | Color large jobs | 324 | 3 |
| SKU 1 | Black and white large jobs | 18729 | 3 |

As illustrated by Table 1, an inventory item may be associated with a particular stock keeping unit (SKU) number. Inventory information may identify a user of item, such as a cell, a current quantity of the item, and a frequency with which the item is used. For instance, the inventory associated with SKU 8 is used by the department, and currently, there are 84 units of the item available in the warehouse.

In an embodiment, a cell may refer to one or more production devices and/or workers that are grouped by the job that it will process. The Cell column in Table 1 indicates the cell that will receive the items in the inventory. For example, the black and white large job cell will receive the inventory on SKU 1. Although not illustrated by Table 1, in various embodiments, more than one cell may receive the same inventory item.

In an embodiment, a user of a simulation system may indicate what types of inventory information the simulation system should receive from a warehouse management system. A user may make a selection of one or more types of inventory information to receive from a warehouse management system by using a graphical user interface. For instance, a user may identify inventory information using checkboxes, text fields, dropdown menus, buttons, hyperlinks and/or any combination of these methods. Additional and/or alternate selection methods may be used within the scope of this disclosure.

A user may identify certain inventory information to be used in one or more simulations. For instance, in a print production environment, inventory information associated with toner may be useful to include in one simulation, while inventory information about media may be useful to include in a different simulation. A user may have the ability to specify which type of inventory information to include.

Referring back to FIG. 2, a simulation system may receive 205 worker information from a people management system. Example worker information that may be received includes, without limitation, information pertaining to workers' schedules, skills, capabilities and/or the like. For instance, in a print production environment, worker information may include a work schedule over a period of time, an indication of which print devices a worker has experience operating, an indication of which print production processes a worker is skilled in and/or the like. Table 2 illustrates example worker information according to an embodiment.

TABLE 2

| Worker | Schedule | | Print Devices | Skills |
|---|---|---|---|---|
| Mike | M | 8 am-4 pm | Multi-function Device 1 | Black-and-White |
| | | | | Printing |
| | T | N/A | Multi-function Device 3 | Color Printing |
| | W | 8 am-4 pm | | Scanning |
| | Th | N/A | | |
| | F | 8 am-4 pm | | |
| Jessica | M | 4 pm-10 pm | Binder 1 | Binding |
| | T | 4 pm-10 pm | Binder 2 | Collating |
| | W | 4 pm-10 pm | Collator 1 | |
| | Th | 4 pm-10 pm | | |
| | F | 4 pm-10 pm | | |
| Paul | M | N/A | Multi-function Device 1 | Black-and-White |
| | | | | Printing |
| | T | 8 am-4 pm | Multi-function Device 2 | Color Printing |
| | W | N/A | Multi-function Device 3 | Scanning |
| | Th | 8 am-4 pm | Binder 1 | Binding |
| | F | N/A | Binder 2 | Collating |
| | | | Collator 1 | |

In an embodiment, a user of a simulation system may indicate what types of worker information the simulation system should receive from a people management system. A user may make a selection of one or more types of worker information to receive from a warehouse management system by using a graphical user interface. For instance, a user may identify worker information using checkboxes, text fields, dropdown menus, buttons, hyperlinks and/or any combination of these methods. Additional and/or alternate selection methods may be used within the scope of this disclosure.

A user may identify certain worker information to be used in one or more simulations. For instance, in a print production environment, worker information associated with certain workers may be useful to include in one simulation, while worker information about other workers may be useful to include in a different simulation. A user may have the ability to specify which type of worker information to include.

In an embodiment, a simulation system may receive 210 equipment information from an equipment management system. Example equipment information that may be received includes, without limitation, information pertaining to one or more devices in a production environment. This information may include one or more device capabilities or functionalities, specification information or other manufacturing information associated with a device such as, for example, a model indicator, a serial number, and/or the like, and/or information pertaining to a current operational state of a device.

For instance, in a print production environment having a multi-function device, equipment information may include a model and/or serial number associated with the multi-function device and an indication of one or more functions the multi-function device is capable of performing. Equipment information may also include an indication of the current operation status of the multi-function device. For example, equipment information may include an indication of whether the multi-function device is currently in use, idle, off, operating in sleep mode and/or the like. Table 3 illustrates example equipment information for example devices in a print production environment according to an embodiment.

TABLE 3

| Device | Model | Functionalities | Status |
|---|---|---|---|
| Printer 1 | Model 1 | Black-and-white printing | In use |
| Printer 2 | Model 2 | Color printing | Idle |
| Multi-function Device | Model 3 | Black-and-white printing | In use |
| | | Color printing | |
| | | Scanning | |

A user of a simulation system may indicate what types of equipment information the simulation system should receive from an equipment management system. A user may make a selection of one or more types of worker information to receive from an equipment management system by using a graphical user interface. For instance, a user may identify equipment information using checkboxes, text fields, dropdown menus, buttons, hyperlinks and/or any combination of these methods. Additional and/or alternate selection methods may be used within the scope of this disclosure.

A user may identify certain equipment information to be used in one or more simulations. For instance, in a print production environment, equipment information associated with certain devices may be useful to include in one simulation, while equipment information about other devices may be useful to include in a different simulation. A user may have the ability to specify which type of equipment information to include.

In an embodiment, a simulation system may receive 215 job information from a job management system. Example job information that may be received includes, without limitation, information pertaining to one or more jobs currently being processed by a production environment, information pertaining to one or more jobs that have already been processed by a production environment, information pertaining to one or more jobs to be processed by a production environment, and/or the like. This information may include a job volume, a job size, one or more setup characteristics associated with a job, turnaround time, and/or the like. A setup characteristic may include a feature of any step in a production process. For example, in a print production environment, a printer setup may be dependent on the type of form used. Alternatively, an insertion operation setup may depend on one or more inserts associated with a job.

In various embodiments, a simulation system may receive inventory information, worker information, equipment information, job information, or any combination thereof. For example, a simulation system may receive inventory information, worker information and job information. As another example, a simulation system may receive worker information and job information. Additional and/or alternate combinations of information may be received within the scope of this disclosure.

A user of a simulation system may indicate what types of job information the simulation system should receive from a job management system. A user may make a selection of one or more types of job information to receive from a job management system by using a graphical user interface. For instance, a user may identify job information using checkboxes, text fields, dropdown menus, buttons, hyperlinks and/or any combination of these methods. Additional and/or alternate selection methods may be used within the scope of this disclosure.

In an embodiment, a user may identify certain job information to be used in one or more simulations. For instance, in a print production environment, job information associated with a certain time period may be useful to include in one simulation, while job information associated with a different time period may be useful to include in a different simulation. A user may have the ability to specify which type of job information to include.

In certain embodiments, at least a portion of the received print production environment information may be standardized. Print production environment information may be received from different systems or types of systems. As such, received information may have significant variability in the types of information and the format of the information across production environments. A simulation system may standardize received information to perform a simulation. Standardizing information may involve converting received information to the same format, reformatting received information, selecting a portion of the received information to include in a simulation and excluding a portion of the received information from the simulation, and/or the like.

Referring back to FIG. 2, a simulation system may receive 220 one or more performance parameters. A performance parameter may be a condition or situation associated with the operation of a production environment. In an embodiment, a performance parameter may be associated with production environment inventory, workers, equipment and/or jobs.

Performance parameters may be used by a user, such as a production environment operator, to predict how a production environment will perform in certain situations. Example simulation parameters may include, without limitation, varying an amount of work to be processed by a production environment, varying an amount of inventory accessible to a production environment, varying an operation status of one or more pieces of equipment in a production environment, varying the schedule of one or more workers and/or the like. In an embodiment, a simulation system may receive 220 one or more performance parameters from a system user.

In an embodiment, one or more operating conditions may be received 225. An operating condition may specify operating policy information associated with a production environment. Operating policy information may indicate a manner in which a job is to be processed. For instance, operating policy information may indicate the order in which jobs will be sequenced such as, for example, earliest due date, shortest processing time, first-in-first-out, and/or the like. Operating policy information may also indicate how one or more jobs are to be routed to production devices, cells and/or the like. For instance, this information may specify that one or more jobs are to be routed based on job size, whether jobs are to be grouped together into larger lots and routed, whether the jobs are to be broken into smaller lots and routed, and/or the like.

In an embodiment, an operating condition may include scheduling information associated with a production environment. Scheduling information may indicate when a production environment is open, closed or otherwise operable or inoperable. In an embodiment, scheduling information may be received 225 from a scheduling system in communication with the simulation system. In another embodiment, scheduling information may be stored by the simulation system.

A simulation may be performed using received inventory information, worker information, equipment information and/or job information, one or more performance parameters, and/or one or more operating conditions to determine what impact, if any, the performance parameter will have on the performance of the production environment. A system user may want to simulate the operation of a production environment under various “what-if” scenarios. A user may model these “what-if” scenarios by specifying one or more performance parameters. For instance, a user may want to simulate the performance of a production environment if a certain worker is not able to work on a particular day. As another example, a user may want to simulate the performance of a production environment if a piece of equipment becomes inoperable, or if a supply of inventory is diminished. Other parameters may include device down times, device production rates, different cellular configurations and/or the like. Additional and/or alternate performance parameters may be used within the scope of this disclosure.

Example impacts that may be revealed by a simulation may include, without limitation, a change in efficiency or throughput of the production system, identification of one or more slow or bottleneck production devices, a need for more or less inventory and/or the like.

A simulation system may receive 220 one or more performance parameters from a computing device associated with a user. A user may use a GUI to identify one or more performance parameters that are to be included in a simulation. For instance, a user may identify one or more performance parameters using checkboxes, text fields, dropdown menus, buttons, hyperlinks and/or any combination of these methods. Additional and/or alternate selection methods may be used within the scope of this disclosure.

A simulation system may receive 225 one or more operating conditions from a computing device associated with a user. A user may use a GUI to identify one or more operating conditions that are to be included in a simulation. For instance, a user may identify one or more operating conditions using checkboxes, text fields, dropdown menus, buttons, hyperlinks and/or any combination of these methods. Additional and/or alternate selection methods may be used within the scope of this disclosure.

In an embodiment, a simulation system may perform 230 a simulation of the operation of a production environment. The simulation may be automatically performed 230. For instance, a simulation may be automatically performed in response to receiving at least a portion of print production information, one or more performance parameters, one or more operating conditions and/or the like in order to simulate the operation of a production environment using substantially real-time information. The simulation system may simulate the operation of a production environment using at least a portion of the received inventory information, worker information, equipment information and/or job information. The simulation may also include at least a portion of the received performance parameters and/or one or more received operating conditions. As such, a simulation system may simulate the performance of a production environment using real-time inventory information, worker information, equipment information and/or job information. Accordingly, the current state of various aspects of a production environment may be captured and incorporated into a simulation model to evaluate their impact of the performance of the production environment.

In an embodiment, a simulation system may perform 230 a simulation by optimizing performance over a certain range of acceptable values for one or more performance parameters. Optimization approaches such as, for example, simulated annealing, genetric algorithms or greed optimization methods may be used.

One or more results of the simulation may be presented 235 to a user. The results of the simulation may include various metrics related to the performance of the production environment under the modeled conditions. Such metrics may include, without limitation, an amount of work the production environment processed, job processing times, total job completion times, job lateness levels, an amount of one or more inventory items that were used during the processing, one or more pieces of equipment that created bottlenecks during processing, operational statuses of one or more pieces of equipment during processing and/or the like.

The results may be presented to a user via a display device, via email and/or the like. For instance, one or more graphs, charts, pictures, images, scales and/or other visual depictions may be displayed to a user on a display device and may illustrate one or more simulation results.

In an embodiment, the simulation system may present 240 a user with one or more recommendations for a production environment. The recommendations may be based at least in part on one or more simulation results, and may include one or more changes that a user can implement to address one or more of the impacts of the modeled performance parameter. Example recommendations may include, without limitation, adding or removing a piece of equipment, changing one or more worker schedules, increasing or decreasing an inventory supply, and/or other changes that increase the efficiency and/or throughput of the production environment.

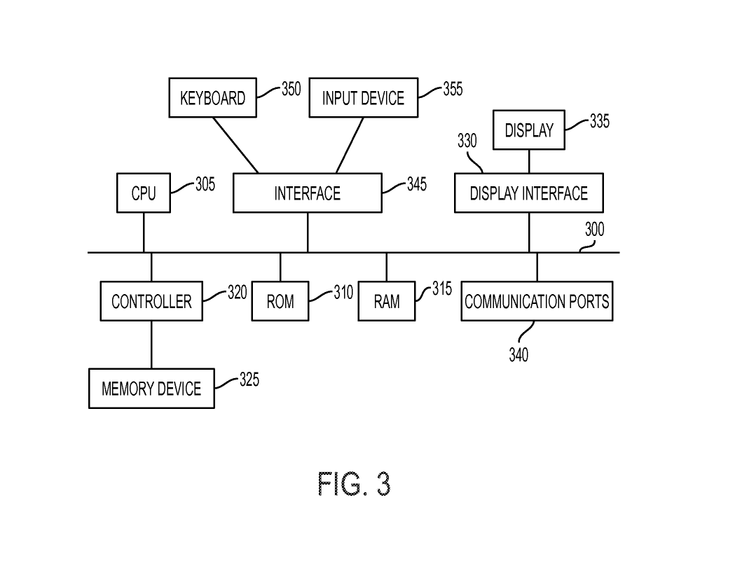

FIG. 3 depicts a block diagram of hardware that may be used to contain or implement program instructions. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an example of a production device, computing device or processor as such terms are used within this disclosure. Read only memory (ROM) 310 and random access memory (RAM) 315 constitute examples of non-transitory computer-readable storage media.

A controller 320 interfaces with one or more optional non-transitory computer-readable storage media 325 to the system bus 300. These storage media 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible non-transitory computer-readable medium such as a compact disk, a digital disk, flash memory, a memory card, a USB drive, an optical disc storage medium and/or other recording medium.

An optional display interface 330 may permit information from the bus 300 to be displayed on the display 335 in audio, visual, graphic or alphanumeric format. Communication with external devices, such as a printing device, may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of simulating performance of a print production environment, the method comprising:
receiving, by a computing device, print production environment information that comprises one or more of the following:
inventory information from a warehouse management system, wherein the inventory information comprises real-time information pertaining to one or more inventory items in a print production environment,
worker information from a people management system, wherein the worker information comprises real-time information pertaining to one or more workers in the print production environment,
equipment information from an equipment management system, wherein the equipment information comprises real-time information pertaining to one or more production devices in the print production environment, or
job information from a job management system, wherein the job information comprises real-time information pertaining to one or more print jobs being processed by the print production environment;
receiving, by the computing device, a performance parameter associated with the print production environment; and
performing, by the computing device, a simulation of operation of the print production environment using the received print production environment information to determine an impact of the performance parameter on the print production environment's performance.

2. The method of claim 1, wherein receiving print production environment information comprises receiving print production environment that comprises a plurality of the following:
the inventory information;
the worker information;
the equipment information; or
the job information.

3. The method of claim 1, further comprising standardizing the received print production environment information before performing the simulation.

4. The method of claim 1, wherein the inventory information comprises one or more of the following for one or more inventory items in the print production environment:
a current amount of the inventory item;
an identity of the inventory item; and
an indication of user of the inventory item in the print production environment.

5. The method of claim 1, wherein the worker information comprises one or more of the following for one or more workers in the print production environment:
information pertaining to the worker's schedule; and
an indication of one or more skills associated with the worker.

6. The method of claim 1, wherein the equipment information comprises one or more of the following for one or more production devices in the print production environment:
one or more functions of the production device;
manufacturing information associated with the production device; and
information pertaining to a current operational state of the production device.

7. The method of claim 1, wherein the job information comprises one or more of the following for one or more print jobs in the print production environment:
a job volume;
a job composition; and
a processing time.

8. The method of claim 1, wherein receiving print production environment information comprises receiving print production environment information that is specified by a user.

9. The method of claim 1, further comprising presenting, by the computing device to a user, one or more results of the simulation via a display device.

10. The method of claim 1, further comprising:
determining one or more recommendations to address the impact; and
presenting the recommendations to a user.

11. The method of claim 1, wherein performing a simulation comprises automatically performing a simulation in response to receiving at least the print production information.

12. The method of claim 1, further comprising:
receiving one or more operating conditions associated with the print production environment,
wherein performing the simulation of operation of the print production environment comprises performing the simulation using the one or more operating conditions.

13. The method of claim 12, wherein the one or more operating conditions comprise one or more of the following:
an indication of how the print jobs will be sequenced;
an indication of how the print jobs will be routed to the one or more production devices; and
scheduling information associated with the print production environment.

14. A system of simulating performance of a print production environment, the system comprising:
a computing device; and
a computer-readable storage medium comprising one or more programming instructions that, when executed, cause the computing device to:
receive print production environment information that comprises one or more of the following:
inventory information from a warehouse management system, wherein the inventory information comprises real-time information pertaining to one or more inventory items in a print production environment,
worker information from a people management system, wherein the worker information comprises real-time information pertaining to one or more workers in the print production environment,
equipment information from an equipment management system, wherein the equipment information comprises real-time information pertaining to one or more production devices in the print production environment, or
job information from a job management system, wherein the job information comprises real-time information pertaining to one or more print jobs being processed by the print production environment;
receive a performance parameter associated with the print production environment; and
perform a simulation of operation of the print production environment using the received print production environment information to determine an impact of the performance parameter on the print production environment's performance.

15. The system of claim 14, wherein the one or more programming instructions that, when executed, cause the computing device to receive print production environment information comprise one or more programming instructions that, when executed, cause the computing device to receive print production environment that comprises a plurality of the following:
the inventory information;
the worker information;
the equipment information; or
the job information.

16. The system of claim 14, wherein the computer-readable storage medium further comprises one or more programming instructions that, when executed, cause the computing device to standardize the received print production environment information before performing the simulation.

17. The system of claim 14, wherein the inventory information comprises one or more of the following for one or more inventory items in the print production environment:
a current amount of the inventory item;
an identity of the inventory item; and
an indication of user of the inventory item in the print production environment.

18. The system of claim 14, wherein the worker information comprises one or more of the following for one or more workers in the print production environment:
information pertaining to the worker's schedule; and
an indication of one or more skills associated with the worker.

19. The system of claim 14, wherein the equipment information comprises one or more of the following for one or more production devices in the print production environment:
one or more functions of the production device;
manufacturing information associated with the production device; and
information pertaining to a current operational state of the production device.

20. The system of claim 14, wherein the job information comprises one or more of the following for one or more print jobs in the print production environment:
a job volume;
a job composition; and
a processing time.

21. The system of claim 14, wherein the one or more programming instructions that, when executed, cause the computing device to receive print production environment information comprises one or more programming instructions that, when executed, cause the computing device to receive print production environment information that is specified by a user.

22. The system of claim 14, wherein the computer-readable storage medium further comprises one or more programming instructions that, when executed, cause the computing device to present to a user one or more results of the simulation via a display device.

23. The system of claim 14, wherein the computer-readable storage medium further comprises one or more programming instructions that, when executed, cause the computing device to:
determine one or more recommendations to address the impact; and
present the recommendations to a user.

24. The system of claim 14, wherein:
the computer-readable storage medium further comprises one or more programming instructions that, when executed, cause the computing device to receive one or more operating conditions associated with the print production environment, wherein the one or more programming instructions that, when executed, cause the
computing device to perform the simulation of operation of the print production environment comprise one or more programming instructions that, when executed, cause the computing device to perform the simulation using the one or more operating conditions, wherein the one or more operating conditions comprise one or more of the following:
an indication of how the print jobs will be sequenced,
an indication of how the print jobs will be routed to the one or more production devices, and
scheduling information associated with the print production environment.
